(19) United States
(12) Patent Application Publication
(10) Pub. No.: US 2010/0104126 A1
(43) Pub. Date: Apr. 29, 2010

(54) TANGLE RESISTANT AUDIO CORD AND EARPHONES

(76) Inventor: Andrea Martina Greene, Flagstaff, AZ (US)

Correspondence Address: BROWN & MICHAELS, PC;400 M & T BANK BUILDING, 118 NORTH TIOGA ST, ITHACA, NY, 14850, US

(21) Appl. No.: 12/434,136

(22) Filed: May 1, 2009

Related U.S. Application Data
(60) Provisional application No. 61/197,054, filed on Oct. 24, 2008.

(51) Int. Cl. H04R 1/00; H01B 7/04

(52) U.S. Cl. 381/384; 174/70 R

(57) ABSTRACT

An audio cord for personal listening audio devices such as earpieces, resistant to tangling and knotting. The audio cords are constructed using shape memory metal alloys and other alloys that allow the audio cords to recover to their original shape after being deflected.

### REFERENCE TO RELATED APPLICATIONS

This application claims one or more inventions which were disclosed in Provisional Application No. 61/197,054, filed Oct. 24, 2008, entitled “HEADPHONES AND EARPHONES WITH TANGLE RESISTANT AUDIO CORD”. The benefit under 35 USC §119(e) of the United States provisional application is hereby claimed, and the aforementioned application is hereby incorporated herein by reference.

### BACKGROUND OF THE INVENTION

1. Field of the Invention

The present invention relates generally to audio cables and personal listening audio devices such as earphones. More particularly, the present invention relates to audio cables for personal listening audio devices such as earphones, that are resistant to tangling and knotting.

2. Description of Related Art

In recent years portable electronic media storage and playing devices requiring listening devices such as earphones have become smaller, lighter, and more easily transportable. Increasingly these portable electronic devices are used throughout the day and are stored in clothing pockets, purses, briefcases, and backpacks. The storage and movement created during transport of earphones can cause the audio cord of these devices to become entangled with itself often forming knots.

Features common to both pacemaker leads and earphones include electrically conductive wires and a polymeric, insulating outer sheath. Audio cords transmit data signals that are converted to audio sound by speakers and pacing leads transmit impulses to heart tissue.

A pacemaker generates a pacing impulse, which travels through the insulated wires of the pacing lead and eventually reaches a metallic electrode at the tip of the lead. The electrode is in direct contact with the heart and delivers the electrical signal to the heart. This signal causes the heart tissue to begin a heartbeat.

In earphone assemblies, audio sound is generated in the following manner. An electronic media storage and playing device is connected to the earphones via a male and female audio jack system. Electrical signals generated by the media playing device travel through the audio jack and audio cords of the earphone assembly, eventually reaching the earphone's audio speaker or speakers. The audio speaker has two electrical points of contact between itself and the audio cord. The typically red contact is known as the live wire and the typically black contact is known as the neutral wire. The electrical signal transmitted through the red live wire rapidly fluctuates between a positive charge and a negative charge. This alternating current causes the polar orientation of the audio speaker's electromagnet to reverse itself at a high frequency, resulting in the creation of audio sound.

State of the art pacing lead technological improvements include lower profile, increased flexibility, and improved fatigue life. In pace maker leads, fatigue resistance of both the polymeric sleeve and the conductive member is desirable. Pace maker leads, unlike earphone audio cords, do not become entangled with themselves or form knots during use. Shape memory alloys can be incorporated into pacing leads as a means for improving fatigue resistance as the pacing lead is deformed with every heart beat.

U.S. Pat. No. 6,717,056 describes a pace maker lead having a shape memory alloy (SMA) member which improves the fatigue resistance of the pacing lead. One SMA element disclosed in U.S. Pat. No. 6,717,056 is a fenestrated ribbon having a thickness between 2 and 250 microns. Another SMA element disclosed in U.S. Pat. No. 6,717,056 is a thin film ribbon helically wound and having a thickness between 2 and 100 microns. Nitinol as well as other shape memory alloys are commonly used in medical device applications where fatigue fracture during the life of the implanted device is a common problem.

Fatigue fracture in the audio cords of earphones rarely occurs and is not a significant problem. State of the art earphone technological improvements include improved sound quality, noise cancellation, and audio cord management techniques. The audio cords of earphones often become tangled and form knots during both use and storage. This problem has been recognized and audio cord management solutions have been employed. The audio cord management techniques currently available provide inadequate solutions to the problem of tangling and knotting in the audio cord of earphones.

U.S. Pat. No. US2007/0165371 A1 describes a protective case for a portable electronic media storage and playing device. The protective case incorporates an earphone audio cord winder, which can be used to store the audio cord when not in use. When used with a portable media playing device this protective case increases the size of the media player which is an undesirable attribute of portable devices. An audio cord winder is only effective if it is actually used by the earphone operator. U.S. Pat. No. US2007/0165371 A1 does not disclose an improved audio cord for earphones having properties that prevent it from becoming tangled.

Monster Cable Products Inc. (Brisbane, Calif.) manufactures earphones having a relatively large flat wire audio cord, which is resistant to tangling. However, the larger audio cord profile and increased mass compared to conventional earphone audio cords readily transmits unwanted vibration to the listener conducted through the audio cable caused by friction, for example, between cable and the user's clothing.

Microsoft Corp. (Redmond, Wash.) manufactures Zune™ Premium earphones, which have an audio cord that incorporates an external woven fabric sheath. The external woven fabric sheath is employed to prevent kinking of the audio cord. However, the surface roughness of the audio cord's external woven fabric sheath readily transmits unwanted vibration to the listener conducted through the audio cable caused by friction, for example, between cable and the user's clothing. The earpieces incorporate magnets used to attach the left and right earpieces to each other to minimize tangling during storage. The magnets incorporated into the right and left earpieces add additional weight and can cause the earpieces to fall out of the user's ears during activities such as running.

U.S. Pat. No. 4,619,246, issued Oct. 28, 1986 discloses a collapsible Nitinol filter basket for use as an implantable medical device.

U.S. Pat. No. 5,025,799, issued Jun. 25, 1991 discloses steerable shape memory alloy guide wires for use in endovascular medical procedures.

U.S. Pat. No. 3,747,619, issued Jul. 24, 1973 discloses a seal-off valve, which incorporates Nitinol.

U.S. Pat. No. 4,037,324, issued Jul. 26, 1977 discloses a system for orthodontic moving of teeth, which incorporates Nitinol.

U.S. Pat. No. 4,649,453, issued Mar. 10, 1987 disclosed a portable cassette tape player.

U.S. Pat. No. 4,453,050, issued Jun. 5, 1984 discloses an earphone that can be used with a portable cassette tape player.

In spite of the widespread use, commercial success, and continued innovation in various fields that use shape memory alloys, and the commercial success, and continued innovation in the portable audio equipment field, the applicability of shape memory alloys to the making of earphones has apparently gone unrecognized.

Earphones having an audio cord that resists tangling and knotting are desired. Some other patents and published applications in this field include US 2008/0044002, U.S. Pat. No. 6,744,901, and US 2007/0053523.

### SUMMARY OF THE INVENTION

The present invention is an improved audio cord for earphones and the like, and earphones having such cords. The cord is constructed using shape memory metal alloys and other metals that allow the earphone audio cord to recover to its original shape after being deflected.

### BRIEF DESCRIPTION OF THE DRAWING

FIG. 1 is a perspective drawing of an earphone assembly.

FIG. 2 is a cross sectional view of the audio cord in accordance with one embodiment of the present invention.

FIGS. 3A and 3B are cross sectional views of the audio cord in accordance with one embodiment of the present invention.

FIGS. 4A and 4B are cross sectional views of the audio cord in accordance with one embodiment of the present invention.

FIGS. 5A and 5B are cross sectional views of the audio cord in accordance with one embodiment of the present invention.

FIGS. 6A and 6B are cross sectional views of the audio cord in accordance with one embodiment of the present invention.

FIG. 7 is a side view drawing of a helically wound coil.

FIG. 8 is a drawing of a partially disassembled earpiece.

FIG. 9A is a side view drawing of a modification process used to attach Nitinol wire to an audio cord.

FIG. 9B is a side view drawing of an audio cord modified with Nitinol wire.

FIG. 10A is a drawing of a step in a process used to modify an earphone assembly with Nitinol wire.

FIG. 10B is a drawing of a polyurethane tube with a longitudinal cut in the wall.

FIG. 10C is a drawing of a step in a process used to modify an earphone assembly with Nitinol wire.

FIG. 10D is a drawing of a step in a process used to modify an earphone assembly with Nitinol wire.

FIG. 11A is a box used to compare the tangle resistance of earphones.

FIG. 11B is a view of a set of earphones.

FIG. 11C is a view of a set of earphones with audio cords modified with Nitinol wire.

FIG. 12A is an illustration of earphones in the original equipment manufacturer packaging.

FIG. 12B is an illustration of earphones in accordance with one embodiment of the present invention packaged in a similar manner to original equipment manufacturer earphones.

FIG. 12C is an illustration of original equipment manufacturer earphones.

FIG. 12D is an illustration of an earphone assembly in accordance with one embodiment of the present invention.

FIGS. 13A-13C are illustrations of earphone assemblies.

### DETAILED DESCRIPTION OF THE INVENTION

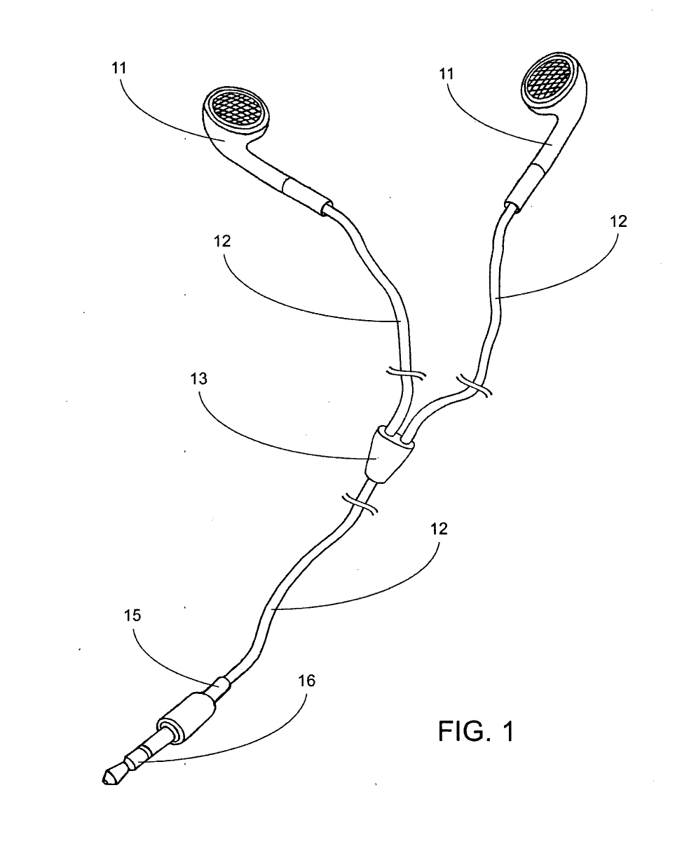

Embodiments of the invention are discussed below with reference to FIGS. 1-13. However, those skilled in the art will readily appreciate that the detailed description given herein with respect to these figures is for explanatory purposes as the invention extends beyond these limited embodiments.

The present invention is an improved earphone assembly and cords for use with such assemblies. The audio cord of the earphone assembly is constructed using shape memory metal alloys and other metals that allow the audio cord to recover to its original shape after being deflected. The invention applies to earphone assemblies with one or more earpieces that fit in the user's ear, on the user's ear, or over the user's ear. Earphone assemblies with earpieces that fit in the user's ear are also known as earbuds. Earphone assemblies with earpieces that fit on the user's ear or over the user's ear are also known as headphones.

Alloys having shape memory properties are suitable for use in the present invention. Alloys which possess shape memory are well known. Articles made of such materials can be deformed from an original undeformed configuration to a second deformed configuration. Such articles revert to the undeformed configuration under specified conditions. They are said to have shape memory.

One set of conditions which will enable a deformed configuration of an article having shape memory to recover towards its undeformed configuration or shape is the application of heat alone. In such an instance the material is spoken of as having an original heat-stable configuration and a second, heat-unstable configuration. The alloy is formed into the heat-unstable configuration at a temperature where it is in a predominantly martensitic phase. Upon application of heat, the article made of such a material can be caused to revert or to attempt to recover from its heat-unstable configuration towards its original heat-stable configuration, i.e., it “remembers” its original shape. Many shape memory alloys exhibit pseudoelastic behavior.

Alloys having pseudoelastic, also known as superelastic, properties are suitable for use in the present invention. Pseudoelastic alloys, when stressed, undergo relatively large strains (up to approximately 8%) which would be recovered upon removal of stress. The recoverable strain of pseudoelastic alloys (up to approximately 8%) is far greater than the recoverable strain of conventional metals (e.g., about 0.3% for steel). A major fraction of pseudoelastic strain occurs under a relatively constant level of stress. Recovery of pseudoelastic strains during stress removal also largely takes place under a relatively constant level of stress. This is unlike elastic strain where during elastic strain occurrence and recovery stress varies in proportion (linearly) with strain.

Pseudoelasticity is exhibited by shape memory alloys within a particular range of temperature. This temperature range can be adjusted to suit particular service conditions of targeted applications through tailoring the composition and processing of alloys. Examples of shape memory alloys exhibiting pseudoelastic behavior include nickel-titanium alloys and copper-based alloys such as Cu—Zn—Al and Cu—Al—Ni.

Shape memory metal alloys such as copper-zinc-aluminum, copper-aluminum-nickel, copper-aluminum-beryllium, and nickel-titanium also known as Nitinol are suitable for use in the present invention.

Nitinol is the preferred shape memory metal alloy for use in the present invention. In general it is desirable for the Nitinol to be straight annealed and pseudo-elastic at room temperature. Other shapes of Nitinol may be used in addition to straight annealed. For example the Nitinol may be shape set into a coil to impart an overall coiled shape to the audio cord of the listening device. In general it is desirable for the majority of the Nitinol to be austenitic and the Af (austenite finish temperature) to be below −20 degrees C. It should be noted that precisely characterizing the metallurgical phases of the Nitinol such as austenite, martensite, and R-phase is not necessary to determine the fitness for use of the material in the present invention.

It should further be noted that precisely characterizing the mechanical properties of the Nitinol such as modulus, upper plateau, lower plateau, and ultimate tensile strength is not necessary to determine the fitness for use of the material in the present invention. Shape memory materials suitable for use in the present invention substantially recover their shape after being deformed.

Shape memory metal alloys can be formed into specific shapes that the material will then return to after being deformed. For example a straight length of Nitinol wire may be wrapped several times around a cylindrical stainless steel mandrel to form a wire coil. To prevent unraveling of the Nitinol wire the ends of the wire must be secured to the mandrel for example by tying the ends of the wire in knots. The Nitinol wire and mandrel are then heated to 500 degrees C. for approximately five minutes. This tempering process imparts the coiled shape to the Nitinol wire. When above the austenitic finish temperature (Af) the wire will return to the coiled shape after being deformed.

Additionally, spring metals suitable for use in springs such as high carbon spring wire, alloy steel wire, stainless steel wire, non-ferrous alloy wire, high temperature alloy wire, and titanium are suitable for use in the present invention. Specific grades of high carbon spring wire include A) music wire (reference ASTM A 228), B) hard drawn (reference ASTM 227), C) high tensile hard drawn (reference ASTM A 679), D) oil tempered (reference ASTM A 229), E) carbon valve (reference ASTM A 230). Specific grades of alloy steel wire include A) chrome vanadium (reference ASTM A 231), B) chrome silicon (reference ASTM A 401). Specific grades of stainless steel wire include A) AISI 302/304 (reference ASTM A 313), B) AISI 316 (reference ASTM A 313), C) 17-7 PH (reference ASTM A 313 (631)). Specific grades of non-ferrous alloy wire include A) phosphor bronze grade A (reference ASTM B 159), B) beryllium copper (reference ASTM B 159), C) monel 400, D) monel K 500. Specific grades of high temperature alloy wire include A) A 286 alloy, B) Inconel 600, C) Inconel 718, D) Inconel ×750. Metals suitable for use in the present invention substantially recover their shape after being deformed.

The SMA or metallic spring member disclosed in the present invention can have various forms. For example, the earphone assembly may incorporate a straight length of a SMA or metallic spring wire having either a round or a square cross section. Additionally, a plurality of SMA or metallic spring members may be used in the present invention. Additionally, round wire formed into a coil having a similar overall appearance to an extension spring is also suitable for use in the present invention. In general, SMA or metallic spring member or members having a total cross sectional area between about 0.125 mm² and 1.25 mm² are suitable for use in the present invention. The axis of this cross section is defined as being perpendicular in orientation to the longitudinal axis of the audio cord.

### Example 1

The presently preferred embodiment of an earphone assembly having an audio cord resistant to tangling and knotting is detailed in Example 1. The audio cord may for example have an extruded plastic outer sheath having multiple lumens in which one lumen contains the electrical wires and the other lumen or lumens contain a shape memory wire or wires. The shape memory metal alloy member or members are oriented longitudinally along the length of the audio cord.

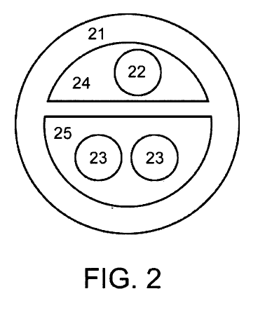

FIG. 2 illustrates a cross-sectional view of an audio cord. The outer sheath 21 has two lumens. The larger of the two lumens 25 contains electrical cords 23 which carry audio signals. The smaller of the two lumens 24 contains a straight annealed pseudo-elastic round Nitinol wire 22 (Part #NW-011-36 Superelastic Nitinol Wire 0.28 mm Diameter, Small Parts, Inc., Miramar, Fla.). The Nitinol wire is electrically insulated from the electrical cords located in the larger lumen.

FIG. 1 illustrates an earphone assembly. The shape memory metal alloy member or members of this example may extend throughout the entire length of the audio cord 12 from the earpiece 11 to the strain relief 15 of the jack 16.

In one embodiment the shape memory alloy member or members may extend from the earpiece 11 to the bifurcation 13 in the audio cord 12 only. Additionally, the shape memory alloy member or members may extend from the bifurcation 13 in the audio cord 12 to the strain relief 15 of the jack 16.

Although various outer sheath multiple lumen profiles and shape memory wire shapes such as square rectangular triangular and ribbon are not used in the illustrated implementation, it should be appreciated that this is not a limitation and that various outer sheath configurations and shape memory wire shapes may be used. For example an outer sheath with an electrical wire lumen and two lumens accommodating square shape memory wires may be used instead of the example illustrated in FIG. 2.

### Example 2

Another embodiment of an earphone assembly having an audio cord resistant to tangling and knotting is detailed in Example 2. The plastic outer sheath of the audio cord is a hollow tube that contains electrical wires and one or more shape memory alloy members. The shape memory metal alloy member or members are oriented longitudinally along the length of the audio cord.

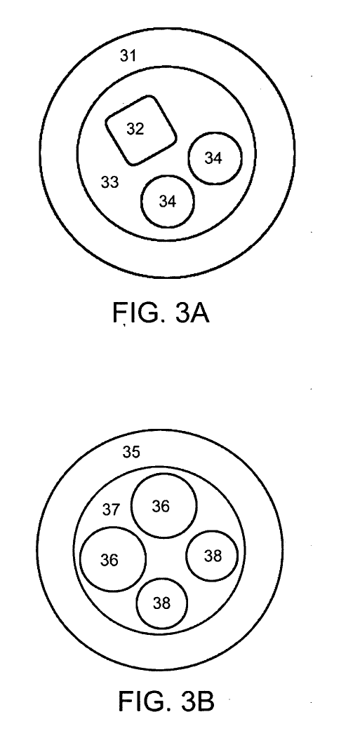

FIG. 3A illustrates a cross-sectional view of an audio cord. The plastic outer sheath 31 is a hollow tube. Inside the lumen 33 of the outer sheath 35 are the electrical wires 34 and a square shape memory wire 32.

FIG. 3B illustrates a cross-sectional view of an audio cord. The plastic outer sheath 35 is a hollow tube. Inside the lumen 37 the outer sheath 35 are the electrical wires 38 and two round shape memory wires 36.

The shape memory metal alloy member or members of this example may extend throughout the entire length of the audio cord 12 from the earpiece 11 to the strain relief 15 of the jack 16. In one embodiment the shape memory alloy member or members may extend from the earpiece 11 to the bifurcation 13 in the audio cord 12 only. Additionally, the shape memory alloy member or members may extend from the bifurcation 13 in the audio cord 12 to the strain relief 15 of the jack 16.

Although various shape memory wire shapes and configurations are not used in the illustrated implementation, it should be appreciated that this is not a limitation and that various wire shapes may be used. For example one oval shape memory wire or 5 round wires may be used instead of the examples illustrated in FIG. 3A and FIG. 3B. Additionally the shape memory wire member or members may have an electrically insulating material surrounding them such as a polymer coating or a plastic tube.

### Example 3

Another embodiment of an earphone assembly having an audio cord resistant to tangling and knotting is detailed in Example 3. The audio cord may for example have a plastic outer sheath in which one or more shape memory metal alloy wires are co-extruded with the outer sheath. The shape memory metal alloy member or members are oriented longitudinally along the length of the audio cord.

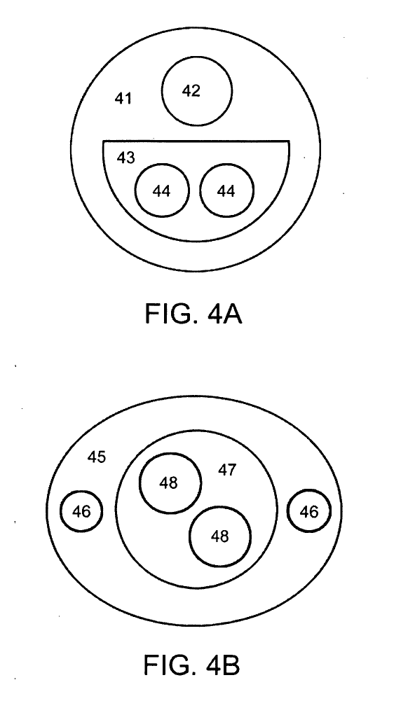

FIG. 4A illustrates a cross-sectional view of an audio cord. The outer sheath 41 is a hollow tube with one round Nitinol wire 42 co-extruded and embedded in the outer sheath 41. The hollow lumen 43 houses the electrical wires 44.

FIG. 4B illustrates a cross-sectional view of an audio cord. The outer sheath 45 is oval in shape and has one lumen 47 which contains the electrical wires 48. Two round Nitinol wires 46 are co-extruded and embedded in the outer sheath 45 material. FIG. 1 illustrates an earphone assembly.

The shape memory metal alloy member or members of this example may extend throughout the entire length of the audio cord 12 from the earpiece 11 to the strain relief 15 of the jack 16. In one embodiment the shape memory alloy member or members may extend from the earpiece 11 to the bifurcation 13 in the audio cord 12 only. Additionally, the shape memory alloy member or members may extend from the bifurcation 13 in the audio cord 12 to the strain relief 15 of the jack 16.

Although various shape memory wire shapes such as square rectangular triangular and ribbon are not used in the illustrated implementation, it should be appreciated that this is not a limitation and that various wire shapes may be used. For example a square wire may be used instead of a round wire in the co-extruded outer sheath of the audio cord 12.

### Example 4

Another embodiment of an earphone assembly having an audio cord resistant to tangling and knotting is detailed in Example 4. The audio cord may for example incorporate a shape memory metal alloy tube. The shape memory metal alloy member is oriented longitudinally along the length of the audio cord.

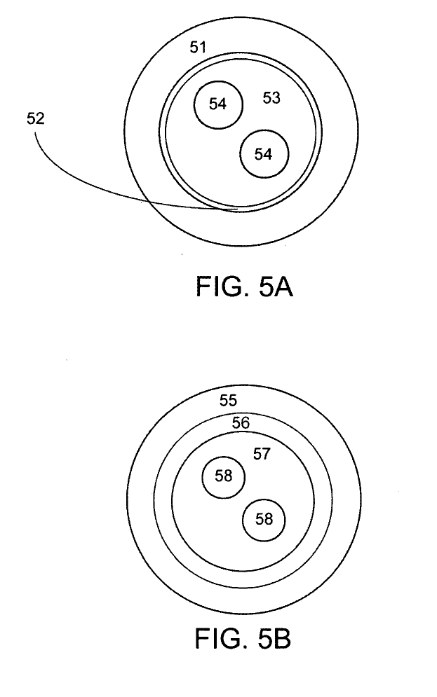

FIG. 5A illustrates a cross-sectional view of an audio cord in which a shape memory metal alloy tube 51 functions as the outer sheath replacing the typical plastic outer sheath. Inside the metal tube 51 is an electrically insulating member 52 such as a plastic tube. The electrical wires 54 are located inside the lumen of the electrically insulating member 52.

FIG. 5B illustrates a cross-sectional view of an audio cord in which a shape memory metal alloy tube 56 is located inside the lumen 57 of the outer sheath 55. The electrical wires 58 are located inside the shape memory alloy tube 56.

The shape memory metal alloy member of this example may extend throughout the entire length of the audio cord 12 from the earpiece 11 to the strain relief 15 of the jack 16. In one embodiment the shape memory alloy member may extend from the earpiece 11 to the bifurcation 13 in the audio cord 12 only. Additionally, the shape memory alloy member or members may extend from the bifurcation 13 in the audio cord 12 to the strain relief 15 of the jack 16. The shape memory metal alloy tube may have holes and other features cut out of the tube to increase the flexibility of the tube. These features and holes may be cut by processes such as laser cutting, water jet cutting, and chemical milling.

### Example 5

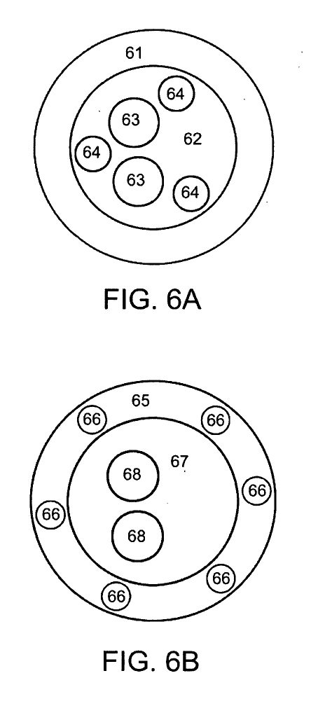

Another embodiment of an earphone assembly having an audio cord resistant to tangling and knotting is detailed in Example 5. The audio cord may for example incorporate multiple shape memory wires formed into a braid. The wire may be braided by hand or by machine. The shape memory wire braid may be located inside the plastic outer sheath 61 as illustrated in FIG. 6A. The shape memory wire braid may also be embedded in the material of the outer sheath by means of co-extrusion. Additionally, the shape memory wire braid may function as the outer sheath replacing the typical plastic outer sheath. The shape memory metal alloy member is oriented longitudinally along the length of the audio cord.

FIG. 6A illustrates a cross-sectional view of an audio cord in which three round Nitinol wires 64 form a braid in the lumen 62 the outer sheath 61 of the audio cord.

FIG. 6B illustrates a cross-sectional view of an audio cord in which six round wires 66 form a braid that is co-extruded with the outer sheath 65.

The shape memory metal alloy members of this example may extend throughout the entire length of the audio cord 12 from the earpiece 11 to the strain relief 15 of the jack 16. In one embodiment the shape memory alloy member may extend from the earpiece 11 to the bifurcation 13 in the audio cord 12 only. Additionally, the shape memory alloy members may extend from the bifurcation 13 in the audio cord 12 to the strain relief 15 of the jack 16.

Although various shape memory alloy wire shapes and braid configurations are not used in the illustrated implementation, it should be appreciated that this is not a limitation and that various wire shapes may be used. For example a braid of seven square wires may be used instead of the braid of three round wires illustrated in FIG. 6A to impart shape memory to the audio cord 12.

### Example 6

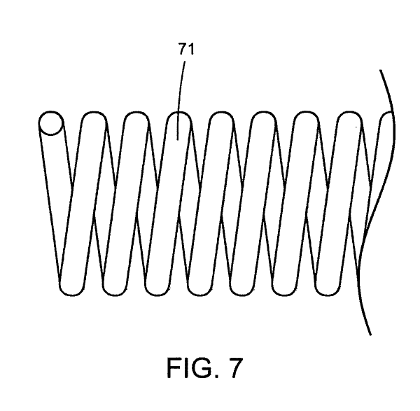

Another embodiment of an earphone assembly having an audio cord resistant to tangling and knotting is detailed in Example 6. The audio cord may for example incorporate shape memory metal alloy wire formed into a helix or coil. FIG. 7 illustrates a side view of a round wire formed into a helical shape. The shape memory metal alloy helix or coil may be located inside or outside the plastic outer sheath. The shape memory metal alloy helix or coil may be co-extruded with the outer sheath of the audio cord. Additionally, the shape memory metal alloy helix or coil may function as the outer sheath replacing the typical plastic outer sheath of the audio cord.

The shape memory metal alloy member is oriented longitudinally along the length of the audio cord.

Additionally, metals suitable for use in springs such as high carbon spring wire, alloy steel wire, stainless steel wire, non-ferrous alloy wire, high temperature alloy wire, and titanium may be used to form the helically shaped member in this example. The higher than average yield strength of these metals allows objects made from them to return to their original shape after being deflected.

The coiled metal members of this example may extend throughout the entire length of the audio cord 12 from the earpiece 11 to the strain relief 15 of the jack 16. In one embodiment the metal coil may extend from the earpiece 11 to the bifurcation 13 in the audio cord 12 only. Additionally, the metal coil member may extend from the bifurcation 13 in the audio cord 12 to the strain relief 15 of the jack 16.

Although various wire shapes and helical wrap configurations are not used in the illustrated implementation, it should be appreciated that this is not a limitation and that various wire shapes and helical wrap configurations may be used. For example a helical shape formed using a square wire may be used instead of a helical shape formed using a round wire to impart shape memory to the audio cord 12.

### Example 7

Another embodiment of an earphone assembly having an audio cord resistant to tangling and knotting is detailed in Example 7.

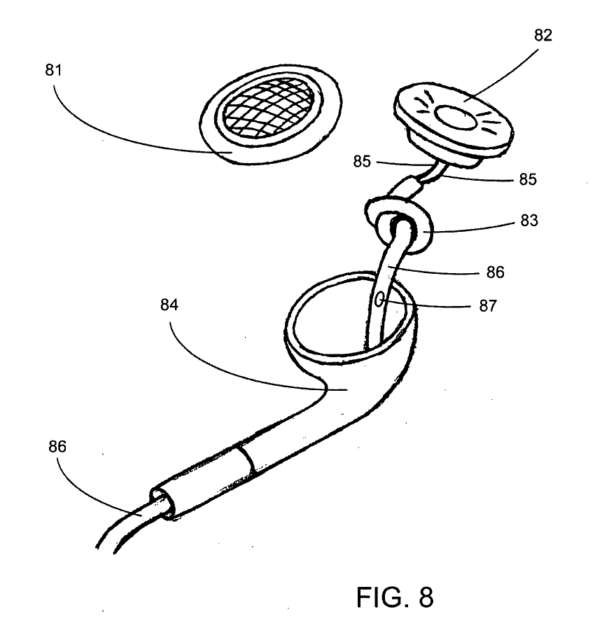

One pair of earphones (Apple iPod Earphones, Apple Computer, Inc., Cupertino, Calif.) was obtained. The left and right earpieces were disassembled and modified in the following manner:
FIG. 8 illustrates the modification process in which the speaker cover 81 was removed from the earpiece housing 84.
The speaker 82 was then removed from the earpiece housing 84 allowing the plastic earpiece housing to freely move across the audio cord 86.
An approximately 1 mm diameter hole 87 was cut into the audio cord outer sheath approximately 1 cm from the knot 83 in the audio cord 86 exposing the wires that carry audio data in the form of electrical signals. This hole 87 cut in the outer sheath of the audio cord allows access to the space between the outer sheath and the electrical wires. The electrical wires 85 are also exposed immediately behind the speaker 82.
An approximately 25 cm length of 0.28 mm diameter straight annealed pseudo-elastic Nitinol wire (Part #NW-011-36 Superelastic Nitinol Wire 0.28 mm Diameter, Small Parts, Inc., Miramar, Fla.) was inserted and advanced through the hole 87 cut in the audio cord outer sheath.
The Nitinol wire was advanced through the hole in the audio cord outer sheath until the end of the wire inserted into the hole 87 reached the audio cord bifurcation 13 as illustrated in FIG. 1.
The approximately 1 cm length of excess Nitinol wire protruding from the hole 87 in the audio cord outer sheath was cut and removed.

The right and left earpieces were then reassembled in the following manner:
The speaker 82 was placed back in the earpiece housing 84.
The speaker cover 81 was then reinstalled over the speaker 82 on the earphone housing 84.

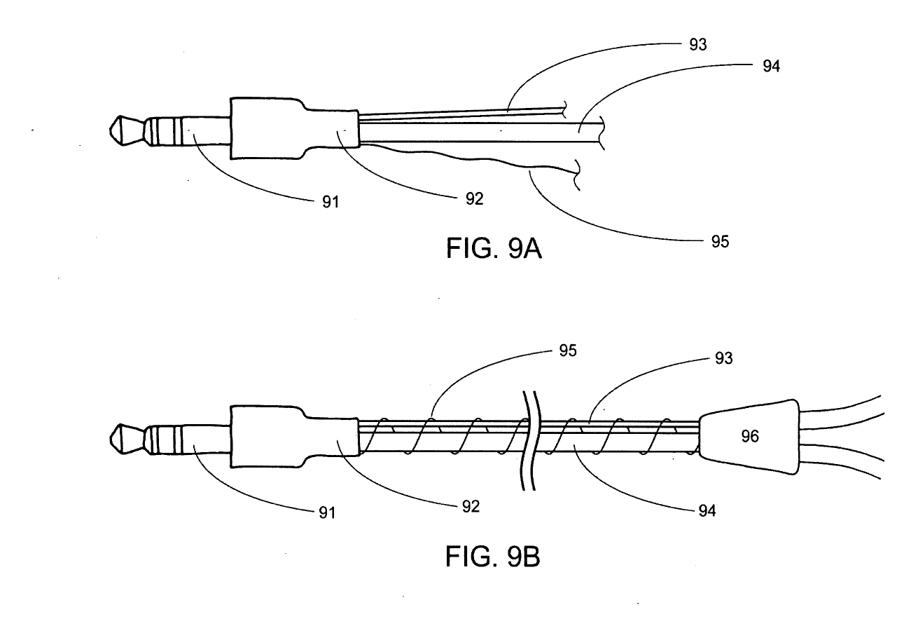

The length of audio cord between the jack 16 and the bifurcation 13 as illustrated in FIG. 1 was modified in the following manner:
FIGS. 9A and 9B illustrate the modification process used to attach the Nitinol wire to the audio cord. One approximately 52 cm length of 0.4826 mm diameter straight annealed pseudo-elastic Nitinol wire (Part #NW-019-36 Superelastic Nitinol Wire 0.4826 mm Diameter, Small Parts, Inc., Miramar, Fla.) was obtained.
A spool of polyester sewing thread (#TEX27 AA White, American & EFIRD, Inc., Mt. Holly, N.C.) was obtained. Cyanoacrylate adhesive (LOCTITE SUPER GLUE, Henkel Consumer Adhesives, Inc., Avon, Ohio) was obtained.
One end of the Nitinol wire was inserted under the strain relief 92 of the audio jack 91 approximately 5 mm.
The thread was also inserted under the strain relief 92 of the audio jack 91 approximately 5 mm.
Both the Nitinol wire and the thread were secured in place under the strain relief with a small amount of cyanoacrylate adhesive.
The thread was then hoop wound approximately one hundred times over the Nitinol wire and the audio cord securing the Nitinol wire to the length of audio cord between the strain relief 92 and the bifurcation 96 as illustrated in FIG. 9B.
The Nitinol wire extended generally longitudinally along the length of audio cord from the strain relief 92 to the bifurcation 96.
The Nitinol wire and thread were secured near the audio cord bifurcation 96 with cyanoacrylate adhesive.

The result of the process is an earphone device, which exhibits a substantial resistance to tangling and knotting of the audio cords.

### Example 8

Another embodiment of an earphone assembly having an audio cord resistant to tangling and knotting is detailed in Example 8. One pair of earphones (Apple iPod Earphones, Apple Computer, Inc., Cupertino, Calif.) was obtained.

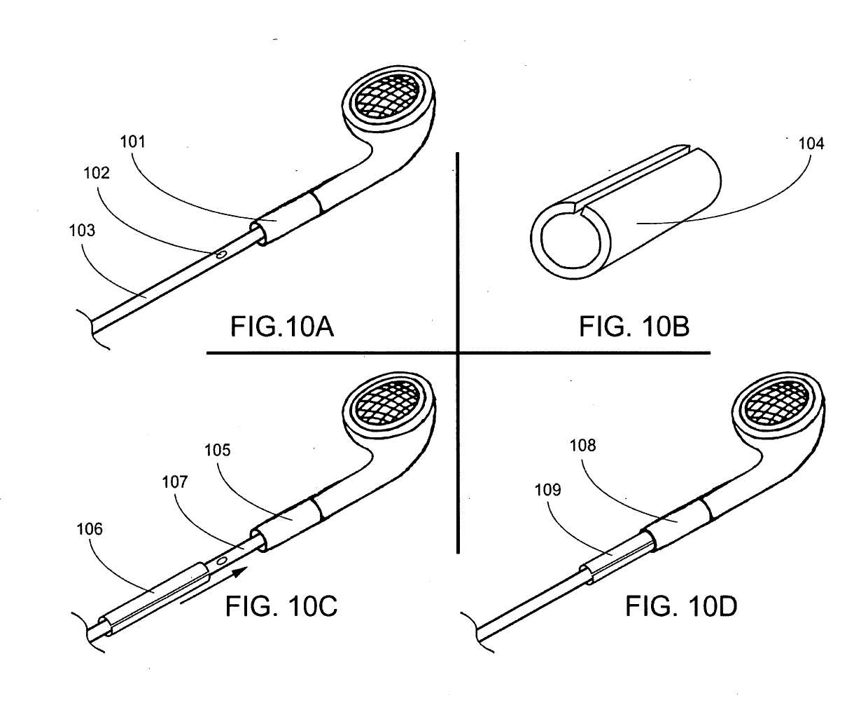

The audio cords between the cord bifurcation and the right and left earpieces were modified in the following manner:
An approximately 1 mm diameter hole 102 was cut into the audio cord 103 outer sheath approximately 6 mm from the end of the strain relief 101 as illustrated in FIG. 10A. The hole 102 cut in the outer sheath of the audio cord allows access to the space between the outer sheath and the electrical wires that carry audio data in the form of electrical signals.
An approximately 33 cm length of 0.381 mm diameter straight annealed pseudo-elastic Nitinol wire (Part #NW-015-12 Superelastic Nitinol Wire 0.381 mm Diameter, Small Parts, Inc., Miramar, Fla.) was inserted and advanced through the hole 102 cut in the audio cord 103 outer sheath.
The Nitinol wire was advanced through the hole 102 in the audio cord 103 outer sheath until the end of the wire inserted into the hole 102 reached the audio cord bifurcation. The audio cord bifurcation 13 is illustrated in FIG. 1.
The approximately 1 cm length of excess Nitinol wire protruding from the hole 102 in the audio cord outer sheath was cut and removed.
An approximately 23 mm length of 3.175 mm OD×1.6 mm ID polyurethane tubing (Part #CPT-0619-10 Superthane Pneumatic Tubing, Small Parts, Inc., Miramar, Fla.) was obtained.
As illustrated in FIG. 10B a longitudinal cut was made through the entire length of the tube 104.
The longitudinal cut made in the polyurethane tubing allowed the tube 106 to be placed over the audio cord 107 as illustrated in FIG. 10C.
As illustrated in FIG. 10C the polyurethane tube 106 was advanced along the audio cord 107 and inserted approximately 8 mm into the strain relief 105.
The polyurethane tube 109 functions as an extension of the existing strain relief 108 as illustrated in FIG. 10D.

The length of audio cord between the strain relief 15 and the bifurcation 13 as illustrated in FIG. 1 was modified with Nitinol wire by the same process described in Example 7.

### Example 9

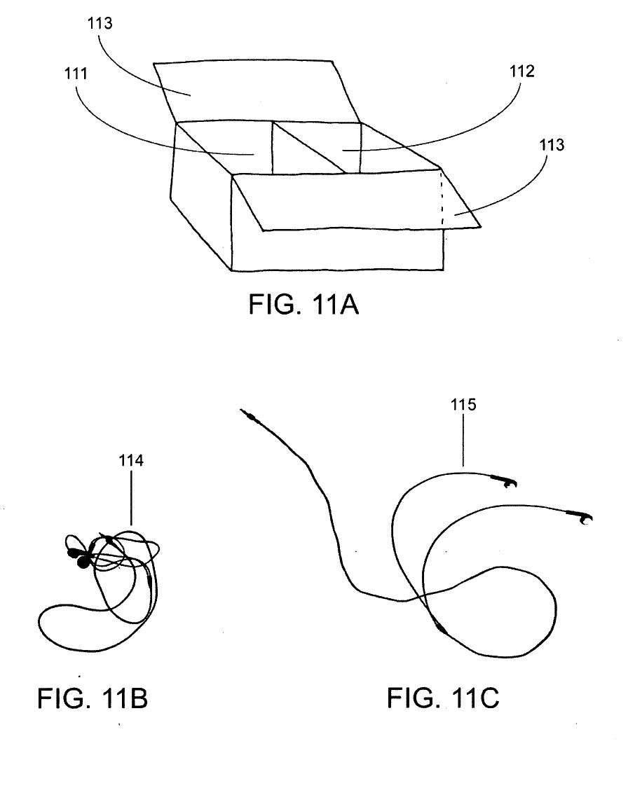

Earphones (Apple iPod Earphones, Apple Computer, Inc., Cupertino, Calif.) and the earphones of Example 8 were comparatively tested for their tendency to tangle. FIG. 11A illustrates a cardboard box having two approximately 30 cm×30 cm×30 cm compartments.

The earphones of Example 8 were placed in one compartment 111 of the box. The stock pair of earphones (Apple iPod Earphones, Apple Computer, Inc., Cupertino, Calif.) was placed in the other compartment 112 of the box. The box lids 113 were then closed and the box was vigorously shaken in various directions for approximately thirty seconds. The box was then opened and turned upside down so that the earphones fell onto a wood floor.

FIG. 11B illustrates the unmodified earphones 114 after the comparative test. FIG. 11C shows the earphones 115 of Example 8 after the comparative test.

### Example 10

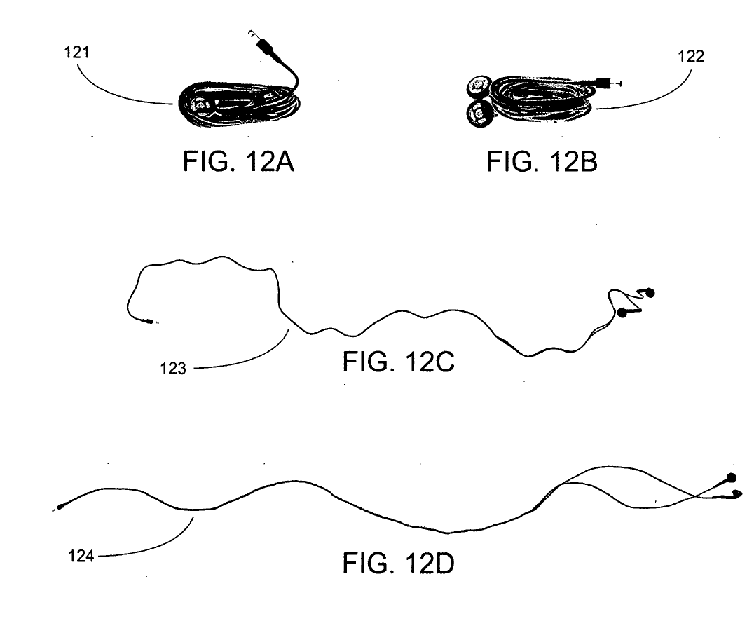

FIG. 12A illustrates earphones 121 (Apple iPod Earphones, Apple Computer, Inc., Cupertino, Calif.) in the original equipment manufacturer packaging. FIG. 12B illustrates earphones 122 from Example 8 packaged in a similar manner to the earphones of FIG. 12A.

The earphones 123 (Apple iPod Earphones, Apple Computer, Inc., Cupertino, Calif.) of FIG. 12C were removed from their original equipment manufacturer packaging, pulled out to their full length, and then left unconstrained. The recovered shape of the earphones 123 is illustrated in FIG. 12C.

The earphones 122 from FIG. 12B were left in the package for twenty-four hours before being removed from their package, pulled out to their full length, and then left unconstrained. The recovered shape of the earphones 124 of Example 8 is illustrated in FIG. 12D.

### Example 11

The invention can be applied to any personal listening device having an audio cord.

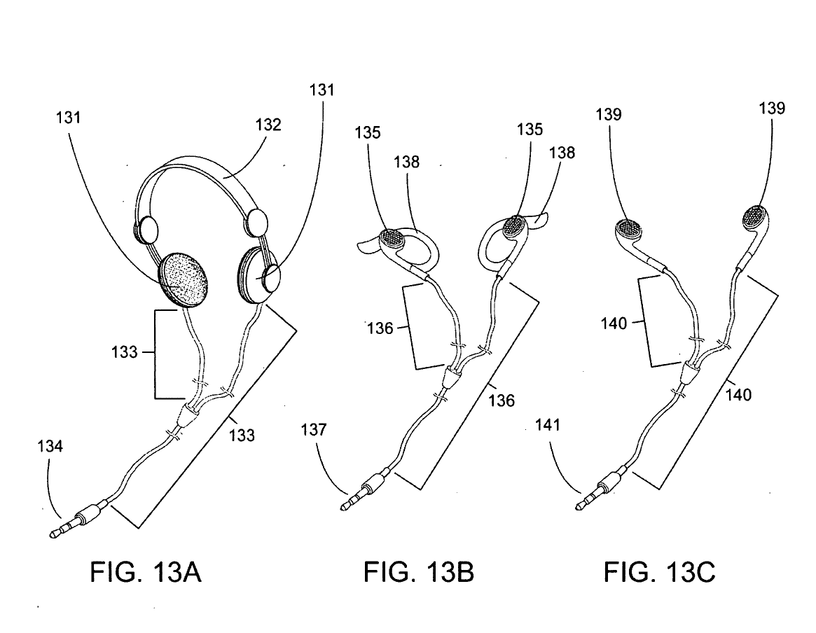

FIG. 13A illustrates an earphone assembly having speakers 131, a head band 132 connecting the speakers, an audio cord 133, and an audio jack 134. The invention can be applied to the entire length of audio cord 133 illustrated in FIG. 13A. Note that the invention does not apply to the head band 132 of FIG. 13A and that the invention does not provide a means for holding the speakers 131 to the user's ears.

FIG. 13B illustrates an earphone assembly having speakers 135, an audio cord 136, an audio jack 137, and curved plastic components 138 used to attach the earpieces to the user's ears. The invention can be applied to the audio cord 136 of the personal listening audio device illustrated in FIG. 13B. Note that the invention does not apply to the curved plastic components 138 used to attach the earpieces to the user's ears and that the invention does not provide a means for holding the speakers 135 to the user's ears.

FIG. 13C illustrates an earphone assembly having speakers 139, an audio cord 140, and an audio jack 141. The invention can be applied to the audio cord 140 of the personal listening audio device illustrated in FIG. 13C.

Although various personal listening device configurations are not used in the illustrated implementation, it should be appreciated that this is not a limitation and that various personal listening devices may be used.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1-14. (canceled)

15. An audio cord having a first end for coupling to an earpiece and a second end terminating in a plug, comprising:
a) at least one electrical wire for powering an earpiece, extending from the first end of the audio cord to the second end, and coupled to a contact in the plug;
b) a spring metal alloy member along a length of the cord; and
c) an outer sheath enclosing the spring metal alloy member and the at least one electrical wire;
such that the audio cord recovers to its original shape after being deflected.

16. The audio cord of claim 15, in which the spring metal alloy member is formed of an alloy selected from the group consisting of high carbon spring wire, alloy steel wire, stainless steel wire, non-ferrous alloy wire, high temperature alloy wire and titanium alloy.

17. The audio cord of claim 15, wherein the spring metal alloy member is electrically insulated from the at least one electrical wire.

18. The audio cord of claim 15, wherein the outer sheath has a plurality of lumens, at least one of the lumens containing an electrical wire and at least one other lumen contains the spring metal alloy member.

19. The audio cord of claim 15, wherein the outer sheath is co-extruded with the spring metal alloy member.

20. The audio cord of claim 15, wherein the spring metal alloy member comprises a plurality of spring metal alloy wires formed into a wire braid.

21. The audio cord of claim 15, wherein the spring metal alloy member is a hollow tube.

22. The audio cord of claim 15, wherein the spring metal alloy member is formed in a helix.

23. The audio cord of claim 15, further comprising a strain relief adjacent an end of the audio cord, and wherein an end of the spring metal alloy member terminates inside the strain relief.

24. The audio cord of claim 15, in which the spring metal alloy member extends longitudinally through a majority of the audio cord, and terminates a distance from an end of the cord.

25. The audio cord of claim 24, in which the spring metal alloy member terminates between 1 and 200 mm from the first end of the cord.

26. The audio cord of claim 15, further comprising at least one earpiece coupled to at least one electrical wire at the first end of the cord.
